(19) United States
(12) Patent Application Publication
(10) Pub. No.: US 2024/0345037 A1
(43) Pub. Date: Oct. 17, 2024

(54) CHARGED AEROSOL DETECTORS

(71) Applicant: Waters Technologies Corporation, Milford, MA (US)

(72) Inventor: Joseph A. Jarrell, Newton Highlands, MA (US)

(73) Assignee: Waters Technologies Corporation, Milford, MA (US)

(21) Appl. No.: 18/634,339

(22) Filed: Apr. 12, 2024

Related U.S. Application Data
(60) Provisional application No. 63/458,758, filed on Apr. 12, 2023.

(51) Int. Cl. G01N 30/12; G01N 30/02; G01N 30/38; G01N 30/72; G01N 30/74

(52) U.S. Cl. CPC G01N 30/12; G01N 30/38; G01N 30/7233; G01N 30/74; G01N 2030/027; G01N 2030/743

(57) ABSTRACT

Embodiments described herein relate to improved devices and techniques for measuring the charge carried by analyte particles. The charge may be measured in a way that does not destroy the analyte, so that the analyte remains available for further analysis. The charged analyte particles may pass through (or by) an electrode. In doing so, they induce a counter charge on that electrode which can be detected electronically. Subsequent to their passage through that electrode, the particles can be collected on a substrate or may pass in real-time into a mass spectrometer. In some embodiments, both conventional destructive detection and nondestructive detection may both be present in an improved charged aerosol detector and the stream of charged particles may be directed to one or the other by a suitable redirector. Embodiments may be combined with light scattering analysis to provide further non-destructive analysis. Various combinations of these improvements are also described.

### CROSS-REFERENCE TO RELATED APPLICATIONS

This application claims the benefit of and priority to U.S. Provisional Patent Application No. 63/458,758, filed Apr. 12, 2023, the entire contents of which are hereby incorporated by reference.

### BACKGROUND

A Charged Aerosol Detector (CAD) is a device that may be used in chromatography. In this respect, it is similar to an Evaporative Light Scattering Detector (ELSD) and a Condensation Nucleation Light Scattering Detector (CNLSD).

All three detectors start by nebulizing a liquid eluent stream from a liquid chromatograph into a gas-borne stream of tiny droplets. These droplets are desolvated. If an analyte is present, this results in a stream of tiny particles. The size of these particles increases as the concentration of an analyte in the eluent stream increases.

In a CAD, the flowing stream of dried particles is charged by mixing it with a stream of ionized nitrogen molecules. Charge transfers from the nitrogen molecules, (and water molecules if present) to the particles of dried analyte. Larger analyte particles absorb a higher charge than smaller ones. The charged analyte particles are then collected on an electrode which is connected to a sensitive electrometer.

One disadvantage of existing charged aerosol detectors is that they destroy the analyte. Thus, the analyte is not available for further analysis.

### BRIEF SUMMARY

Exemplary embodiments relate to apparatuses for the non-destructive analysis of charged analyte particles, as well as methods for using the apparatuses.

In one aspect, an apparatus for use with a charged aerosol detector (CAD) front-end includes a detection tube or electrode configured to receive charged particles, where the detection tube or electrode is configured so that charged particles passing through or near the detection tube or electrode induce a counter charge on the detection tube or electrode. The apparatus further includes a detector configured to detect the counter charge, and an outlet configured to output the charged particles after passing through or near the detection tube or electrode. The charged particles remain available for further analysis after passing through the outlet.

In some embodiments, a charge sensitive amplifier may be configured to receive an input charge corresponding to the detected counter charge and generate an output voltage that is proportional to the input charge.

In some embodiments, the outlet includes a collection substrate configured to collect the charged particles after passing through or near the detection tube or electrode. Alternatively or in addition, the outlet may include an exhaust that allows the particles to pass in real-time to a subsequent analysis device.

In the case where the charged particles are collected, the apparatus may also include a subsequent analysis device configured to receive the charged particles collected on the collection substrate. The subsequent analysis device may be a Fourier-transform infrared (FTIR) spectrometer or a matrix-assisted laser desorption/ionization (MALDI) mass spectrometer (MS).

In the case where the particles are passed in real-time to a subsequent analysis device, the subsequent analysis device may be a particle beam mass spectrometer or a laser ablation-ionization mass spectrometer, or an extractive electrospray interface to a mass spectrometer. Extractive electrospray is a term of art to describe a process in which neutral analyte molecules, analyte molecules dissolved in uncharged droplets, or analyte molecules in dried particles, are ionized by interacting or mixing with an analyte-free electrospray.

The apparatus may further include a light scattering unit having a light source and a light scattering detector, where the light scattering unit is provided upstream of the detection tube.

The detection tube or electrode, detector, and outlet may form a nondestructive CAD module. In some embodiments, the apparatus further includes a destructive CAD module. The destructive CAD module may be fluidically connected with the outlet so that the nondestructive CAD module and the destructive CAD module are provided in series with each other. Alternatively, the nondestructive CAD module and the destructive CAD module may be provided in parallel with each other, with a redirector configured to selectively direct the charged particles to the nondestructive CAD module or the destructive CAD module.

The redirector may be a switching valve includes a destructive path and a nondestructive path, the charged particles being directed into the destructive path or nondestructive path depending on a state of the switching valve. Alternatively or in addition, the redirector may be an electrostatic or pneumatic redirector configured to direct the charged particles to the destructive CAD module or the nondestructive CAD module.

In some embodiments, a first adapter on the nondestructive CAD module may be configured to mate with a corresponding adapter on the CAD front-end. A second adapter on the destructive CAD module may be configured to mate with the corresponding adapter on the CAD front-end.

The charged aerosol detector front-end may include an inlet configured to provide an analyte, a nebulizer configured to receive the analyte and form an aerosol which includes the analyte, a spray chamber configured to condition the aerosol by removing droplets larger than a predetermined size, an evaporation tube configured to condition remaining droplets in the aerosol by evaporating solvent from the remaining droplets to form dried particles, a charger configured to output charged particles, a mixing chamber configured to receive the dried particles and the charged particles and to mix the dried particles and charged particles together to form mixed particles, and an ion trap configured to receive the mixed particles and output selected particles from the mixed particles, where the detection tube or electrode is configured to receive the selected particles from the ion trap.

In another embodiment, an apparatus includes an inlet configured to provide an analyte, a nebulizer configured to receive the analyte and form an aerosol which includes the analyte, a spray chamber which may or may not be configured to condition the aerosol by removing droplets larger than a predetermined size, an evaporation tube configured to condition remaining droplets in the aerosol by evaporating solvent from the remaining droplets to form dried particles, a charger configured to output charged particles, a mixing chamber configured to receive the dried particles and the charged particles and to mix the dried particles and charged particles together to form mixed particles, an ion trap configured to receive the mixed particles and output selected particles from the mixed particles, where the detection tube or electrode is configured to receive the selected particles from the ion trap, and a light-scattering unit that includes a light source and a scattered light detector, where the light scattering unit is arranged upstream of the mixing chamber to measure light scattered by the dried particles before the dried particles are mixed with the charged particles.

The above-described apparatus may be used to analyze an analyte. According to one exemplary method, the analyte may be provided to an inlet of the CAD front-end noted above, and may be analyzed using the detection tube or electrode and the detector. A further analysis may be performed on the charged particles output at the outlet.

The method may also include performing a light scattering analysis prior to analyzing the CAD analyte with the detection tube or electrode and the detector.

In some embodiments, the detection tube or electrode, detector, and outlet form a nondestructive CAD module, and the method may further include providing a destructive CAD module. The apparatus may switch between the nondestructive CAD module and the destructive CAD module.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an example of a conventional charged aerosol detector.

FIG. 2 depicts an improved nondestructive charged aerosol detector in accordance with one embodiment.

FIG. 3A depicts a destructive charged aerosol detector combined with a non-destructive light-scattering analyzer in accordance with one embodiment.

FIG. 3B depicts a nondestructive charged aerosol detector combined with a non-destructive light-scattering analyzer in accordance with one embodiment.

FIG. 4 depicts a nondestructive charged aerosol detector combined in series with a destructive charged aerosol detector in accordance with one embodiment.

FIG. 5A depicts a charged aerosol detector front-end that can be connected to destructive or nondestructive analysis modules in accordance with one embodiment.

FIG. 5B depicts a charged aerosol detector front-end that connected via a redirector to destructive and nondestructive analysis modules in accordance with one embodiment.

FIG. 6 illustrates an example of a mass spectrometry system according to an exemplary embodiment.

FIG. 7 is a flow chart describing an exemplary method for using the apparatuses described herein.

### DETAILED DESCRIPTION

Exemplary embodiments provide improved nondestructive devices and techniques to measure the charge carried by the analyte particles. In exemplary embodiments the charged analyte particles pass through (or by) an electrode. In doing so, they induce a counter charge on that electrode which can be detected electronically.

Subsequent to their passage through that electrode, the particles can be collected on a substrate, for example, where they can be subjected to further analysis. For instance, the particles on the substrate may be provided to a Fourier-transform infrared (FTIR) spectrometer or a matrix-assisted laser desorption/ionization (MALDI) mass spectrometer (MS). Alternatively or in addition, the particles could pass in real-time into a further analysis device, such as a particle beam mass spectrometer or a laser ablation-ionization mass spectrometer or an extractive electrospray interface to a mass spectrometer.

In a further embodiment, both conventional destructive detection and improved nondestructive detection paradigm may both be present in an improved charged aerosol detector. In some cases, the nondestructive detector may be provided in series with a destructive detector. In others, both types of detectors may be available, and the stream of charged particles may be directed to one or the other by an electrostatic and/or pneumatic redirector or a switching valve. In further embodiments, the nondestructive and destructive detectors may be available as separate modules that can be connected to a CAD front-end. These embodiments are useful because one instrument can provide both detection paradigms. In a quality control environment, for example, a previously-approved method may specify the detection paradigm to be used, and embodiments providing both methods allow the approved method to be carried out regardless of the specified paradigm.

An additional improvement, which can be used in combination with any of the embodiments discussed above, is the incorporation of a light scattering unit upstream of the aerosol charging element. This is possible as light scattering detection is non-destructive.

Various combinations of these improvements are also possible and contemplated.

### Exemplary Embodiments

As an aid to understanding, a series of examples will first be presented before detailed descriptions of the underlying implementations are described. It is noted that these examples are intended to be illustrative only and that the present invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

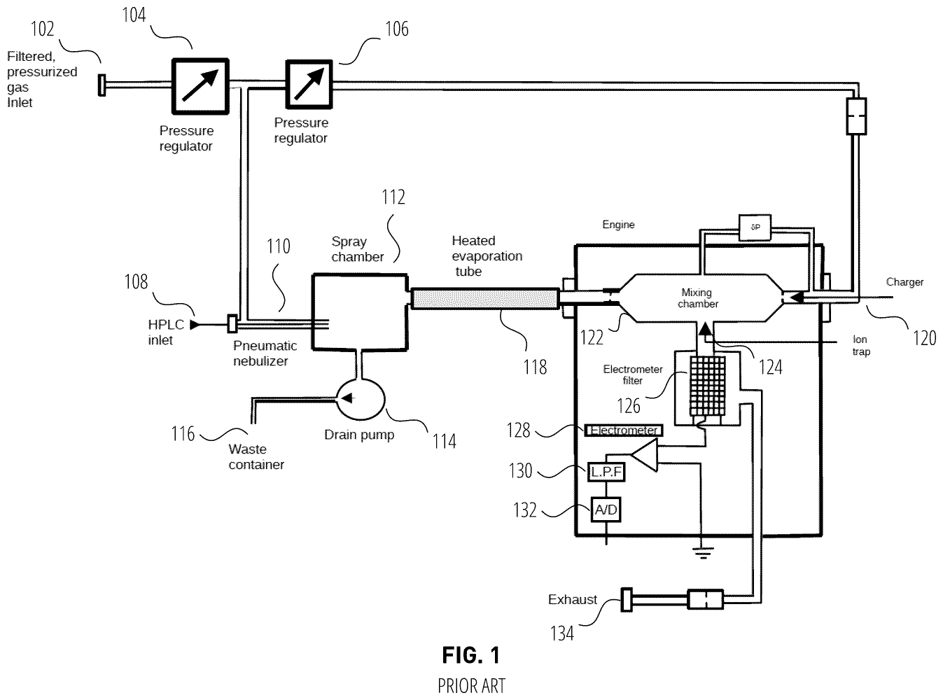

FIG. 1 depicts, for comparison purposes, an example of a conventional charged aerosol detector (CAD).

A gas inlet 102 receives filtered, pressurized gas (such as nitrogen gas) that acts as a carrier for the analyte. The gas may be received, for example, a pressure of 40-80 psi. The gas may be provided to a pressure regulator 104 that keeps the gas at a target pressure.

The filtered, pressurized gas then passes to a T-junction that directs some of the filtered, pressurized gas to a pneumatic nebulizer 110 where it is combined with the analyte. The analyte entering pneumatic nebulizer 110 may be received in a liquid stream from a high performance liquid chromatography (HPLC) inlet 108.

The pneumatic nebulizer 110 nebulizes the liquid stream, thereby converting it into a gas-borne stream of tiny droplets. The aerosol is sprayed into a spray chamber 112, which optionally may be designed to condition the aerosol to remove relatively large droplets (e.g., droplets larger than a predetermined size). The large droplets naturally drop towards a drain at the bottom of the spray chamber 112, where a drain pump 114 carries them to a waste container 116.

The droplets then are carried to a heated evaporation tube 118 where solvent is evaporated from the droplets to leave dried particles. Thus a higher concentration of analyte in the liquid stream from HPLC inlet 108 introduced into pneumatic nebulizer 110 will produce an aerosol of dried particles with larger average diameters. The dried particles are then provided to one entrance to a mixing chamber 122.

Meanwhile, some of the filtered, pressurized gas from the gas inlet 102 exits the T-junction towards another pressure regulator 106. The regulated gas is then provided to a charger 120. The charger 120 adds a charge to the filtered, pressurized gas molecules, typically nitrogen although water molecules are also charged if present, such as by forming an ion jet via corona discharge. The resulting charged particles are then provided to another entrance to the mixing chamber 122.

In the mixing chamber, the dried particles are mixed with the charged particles so that the charge from the charged particles is substantially transferred to the dried particles. Here, larger analyte particles absorb a higher charge than smaller particles, which allows the concentration of the analyte to be determined by measuring the particle charges. An ion trap 124 is used to remove the excess nitrogen or water particles. The remaining charged particles are then collected by an electrode such as an electrically conductive filter 126 that allows gas to pass through while substantially capturing the charged particles. The collection of these charged dried analyte particles is registered by a sensitive electrometer 128. Since a higher analyte concentration produces large diameter particles and large particles carry more charge after mixing chamber, the current measured by electrometer 128 is also a measure of analyte concentration To support this determination, the CAD may make use of electronics such as a low pass filter 130 and an analog/digital converter 132. Any remaining gas is exhausted from the CAD through the exhaust 134. Unfortunately, most of the analyte is consumed when it impacts on the electrometer filter 126 and what remains is generally insufficient for performing further analysis.

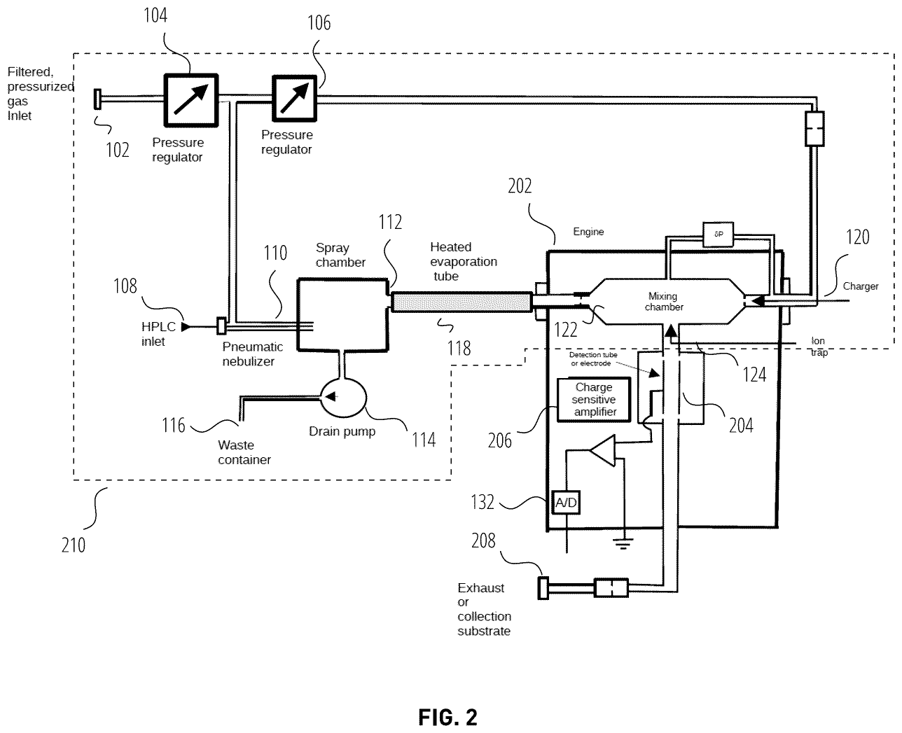

FIG. 2 depicts an improved charged aerosol detector that does not destroy the analyte in the process of measuring the numbers of different particles within it. As shown in FIG. 2, the gas inlet 102, pressure regulator 104, pressure regulator 106, HPLC inlet 108, pneumatic nebulizer 110, spray chamber 112, drain pump 114, waste container 116, heated evaporation tube 118, charger 120, mixing chamber 122, and ion trap 124 remain the same; further discussion of these elements is therefore omitted for purposes of brevity. These elements make up a CAD front-end 210 that is connected to a detection module 202 forming the improved detection portion of the CAD.

In the detection module 202, the charged particles pass through or near a detection tube/electrode 204. The detection tube/electrode 204 is an electrical conductor, and as the particles pass near/through it, they induce a counter-charge in the detection tube/electrode 204 that can be detected electronically. In order to use as little capacitance as possible, the counter charge from the detection tube/electrode 204 may be provided as an input to a charge sensitive amplifier 206. The charge sensitive amplifier 206 converts the input charge into a voltage and amplifies it (e.g., provides an output voltage proportional to the input charge). An analog/digital converter 132 converts the output of the charge sensitive amplifier 206 so that the resulting data can be analyzed to detect the amounts of various molecules present in the analyte. Supplemental gas flow may optionally e introduced into detection tube/electrode 204 to assist in guiding the flow of charged particles.

The analyte is not consumed by this process, since the charge on the particles is detected indirectly through the presence of the countercharge on the detection tube/electrode 204. The charged particles can thus be collected in a collection substrate at the outlet. Alternatively or in addition, the outlet may include an exhaust that allows the particles to pass in real-time to a subsequent analysis device.

In the case where the charged particles are collected, the apparatus may also include a subsequent analysis device configured to receive the charged particles collected on the collection substrate. The subsequent analysis device may be a Fourier-transform infrared (FTIR) spectrometer or a matrix-assisted laser desorption/ionization (MALDI) mass spectrometer (MS).

In the case where the particles are passed in real-time to a subsequent analysis device, the subsequent analysis device may be a particle beam mass spectrometer or a laser ablation-ionization mass spectrometer or an extractive electrospray interface to a mass spectrometer.

The output of the detection module 202 is referred to as an exhaust/collection substrate 208 herein to accommodate both possibilities.

Another form of non-destructive analysis is light scattering spectroscopy, in which light is shined on the analyte particles. The light then interacts with the particles and is scattered (with larger particles scattering the light more). The resulting pattern can be analyzed to study the particles in the analyte.

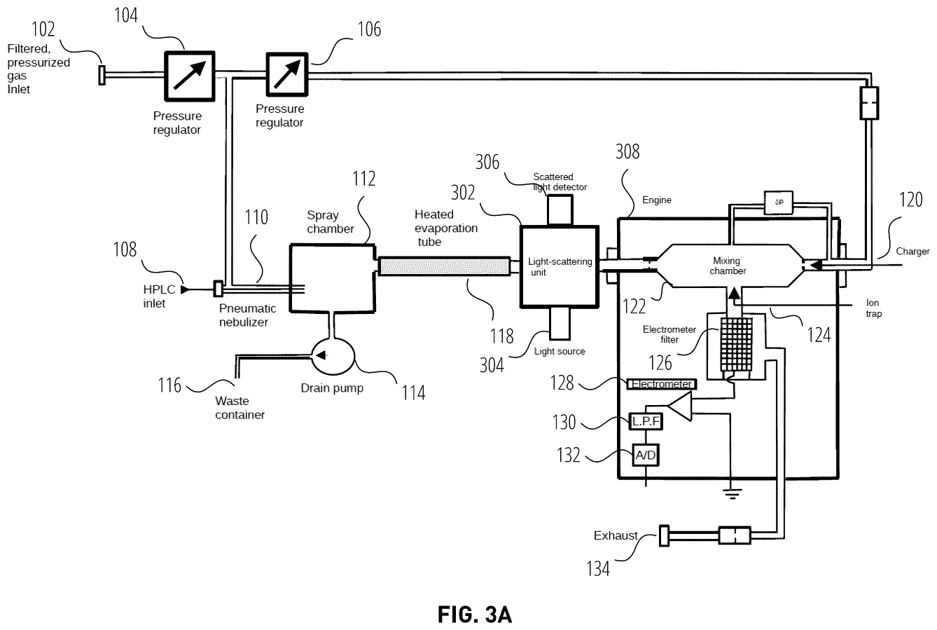

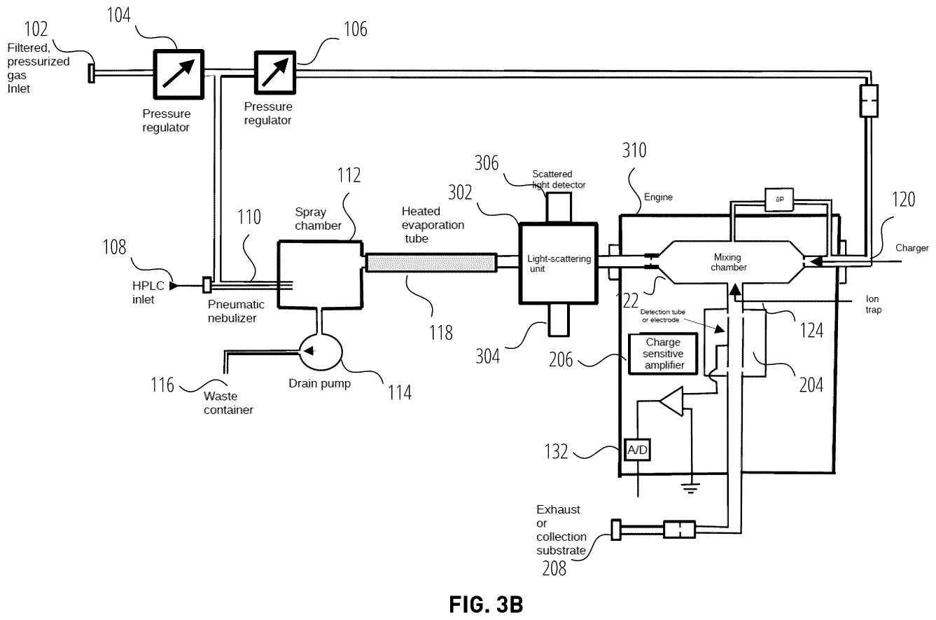

In some embodiments, a light scattering unit 302 having a light source 304 and a scattered light detector 306 may therefore be provided upstream of the mixing chamber 122. This can be placed in line with a conventional destructive analysis module 308 (as shown in FIG. 3A), and/or with the improved nondestructive analysis module 310 (as shown in FIG. 3B).

For the sake of brevity, the light scattering unit 302 is omitted from further embodiments; however, it is contemplated that a light scattering unit 302 may be deployed upstream of a destructive analysis module 308 or nondestructive analysis module 310 in any of the embodiments described herein.

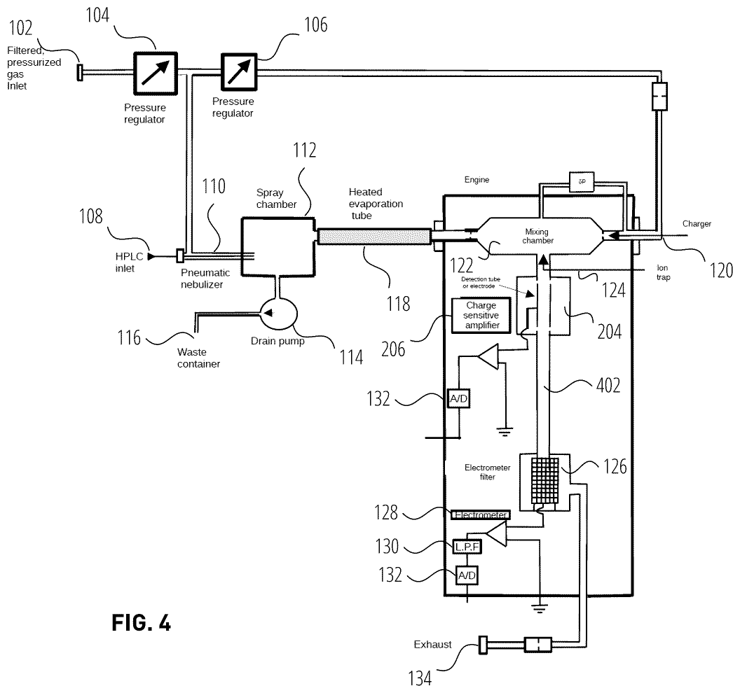

FIG. 4 depicts a further embodiment in which the nondestructive analysis module 310 and the destructive analysis module 308 are provided together in a single apparatus. The nondestructive analysis module 310 and destructive analysis module 308 are provided in series in this example, with the nondestructive analysis module 310 coming before the destructive analysis module 308. After the analyte passes through the detection tube/electrode 204 in this example, it passes to an outlet 402 of the nondestructive analysis module 310 and from there to the electrometer filter 126 of the destructive analysis module 308. In this way, both detection schemes can be employed (which may yield a more thorough or accurate analysis of the analyte). The disadvantage of this approach is that the analyte is destroyed at the end of the process, when it impacts on the electrometer filter 126 of the destructive analysis module 308.

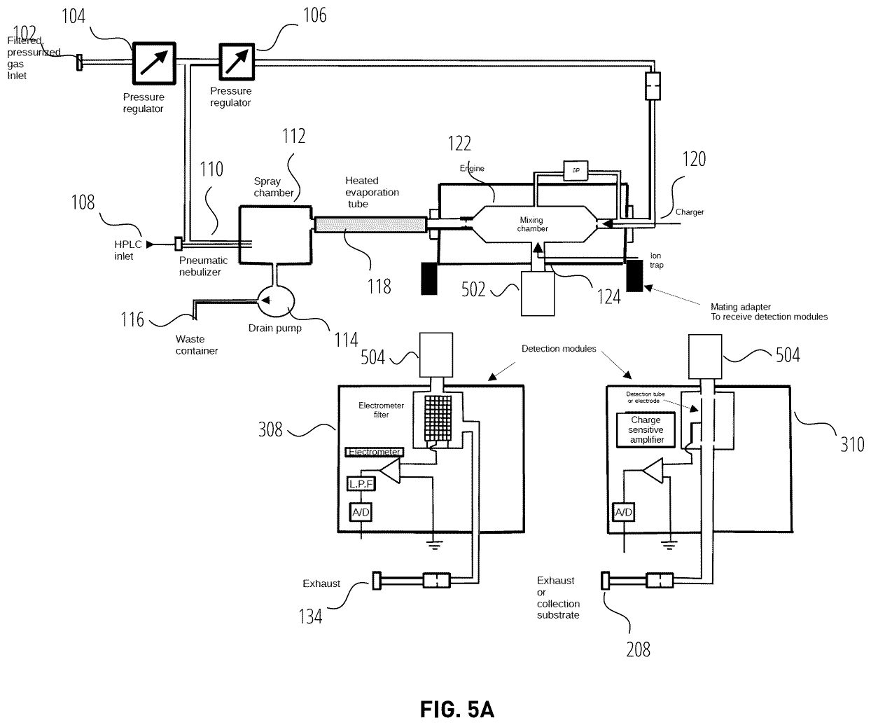

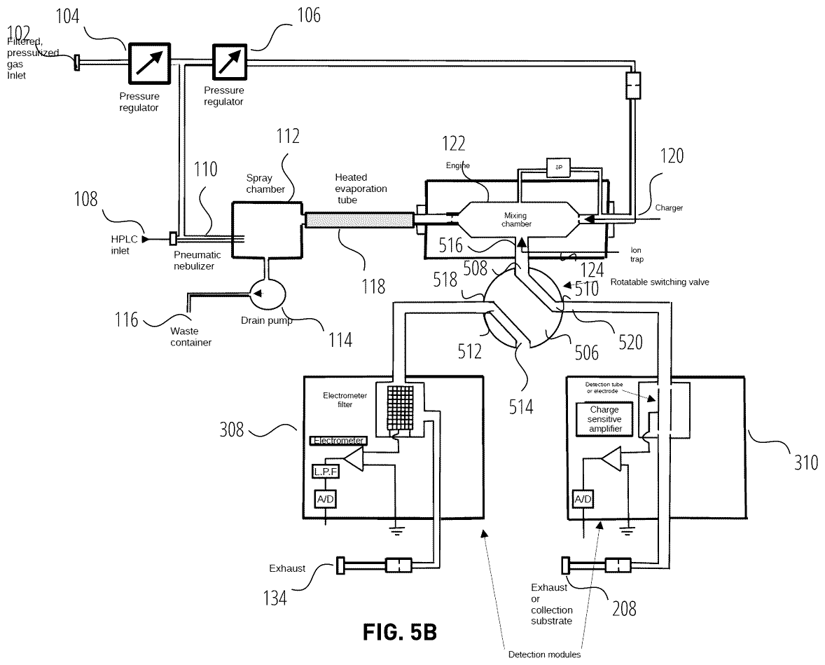

In some cases, it may be helpful to provide either a destructive option for which existing protocols may be designed, and an improved nondestructive option that allows for further processing of the analyte. For example, some quality control processes rely on methods that have been vetted and approved (e.g., by regulatory agencies or standards organizations); such processes might accept results from a destructive method but not from a non-destructive method (at least until the nondestructive method is vetted and accepted by the approving organization). Accordingly, some embodiments package the destructive and nondestructive analysis equipment into discrete modules, which can be swapped out for one another (FIG. 5A) or switched between (FIG. 5B).

For instance, in FIG. 5A the CAD front-end 210 terminates at an adapter 502. The adapter 502 is sized and shaped to mate with corresponding mating adapters 504 provided at the inlet of the destructive analysis module 308 and nondestructive analysis module 310. For example, the adapter 502 may include a screw-in or quick-change connection that attaches to the mating adapter 504. This allows one module to be removed and replaced by another.

FIG. 5B, meanwhile, provides both the destructive analysis module 308 and the 310 in parallel to each other. At the mixing chamber outlet 516, after the ion trap 124, a rotatable switching valve 506 is provided. The switching valve 506 includes two distinct paths-one leading from a valve nondestructive inlet 508 to a valve nondestructive outlet 510, and another from a valve destructive inlet 512 to a valve destructive outlet 514.

When the switching valve 506 is in a first state (as shown in FIG. 5B), the switching valve 506 is rotated to a position where the mixing chamber outlet 516 aligns with the valve nondestructive inlet 508, which causes the gas to flow through the valve nondestructive outlet 510 and into a nondestructive module inlet 520 that then provides the gas to the nondestructive analysis module 310.

Conversely, when the switching valve 506 is rotated into a second state, the valve destructive inlet 512 aligns with the mixing chamber outlet 516. This causes the gas to flow to the valve destructive outlet 514 and into a destructive module inlet 518, which provides the gas to the destructive analysis module 308.

Thus, a user can select between the destructive analysis module 308 and nondestructive analysis module 310 by rotating the switching valve 506. More generally, other techniques for redirecting the charged particles can be employed, such as a different type of valve or electrostatic or pneumatic redirection.

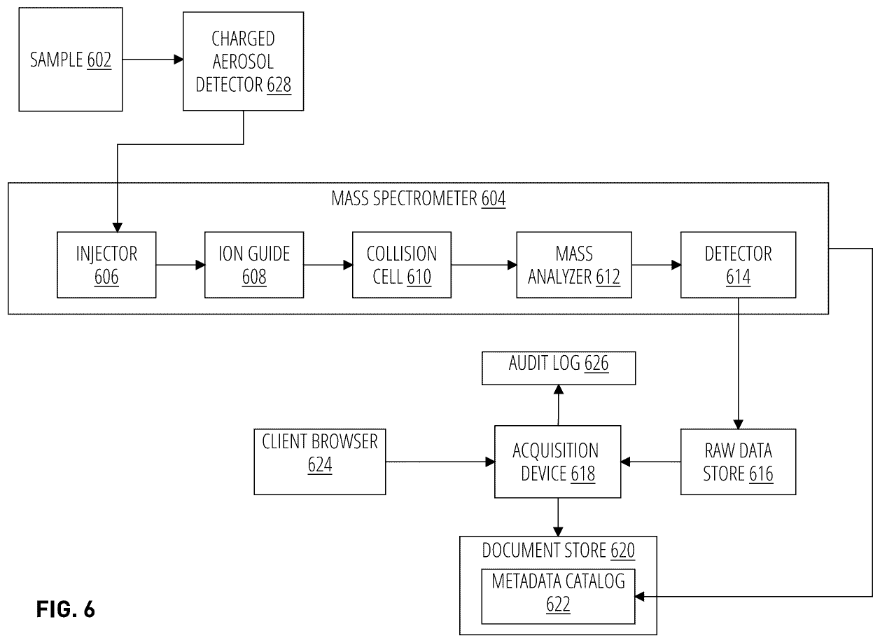

For purposes of illustration, FIG. 6 is a schematic diagram of a system that may be used in connection with techniques herein. Although FIG. 6 depicts particular types of devices in a specific MS configuration, one of ordinary skill in the art will understand that different types of chromatographic devices (e.g., LCMS, MS, tandem MS, etc.) may also be used in connection with the present disclosure.

A sample 602 is injected into a charged aerosol detector 628 through the HPLC inlet 108. The output from the charged aerosol detector 628 may be input to a mass spectrometer 604 for analysis. For example, the output from the charged aerosol detector 628 may be collected on a collector or output by an exhaust for further analysis. If the output from charged aerosol detector 628 is collected on a substrate, the collected dry analyte particles can be redissolved in an appropriate mobile phase so that it can be injected into injector 606 of mass spectrometer 604.

At the mass spectrometer 604, initially the sample is desolvated and ionized by a desolvation/ionization device, such as the injector 606. Desolvation can be any technique for desolvation, including, for example, a heater, a gas, a heater in combination with a gas or other desolvation technique. Ionization can be by any ionization techniques, including for example, electrospray ionization (ESI), atmospheric pressure chemical ionization (APCI), matrix assisted laser desorption (MALDI) or other ionization technique. Ions resulting from the ionization are fed to a collision cell 610 by a voltage gradient being applied to an ion guide 608. Collision cell 610 can be used to pass the ions (low-energy) or to fragment the ions (high-energy).

Different techniques (including one described in U.S. Pat. No. 6,717,130, to Bateman et al., which is incorporated by reference herein) may be used in which an alternating voltage can be applied across the collision cell 610 to cause fragmentation. Spectra are collected for the precursors at low-energy (no collisions) and fragments at high-energy (results of collisions).

The output of collision cell 610 is input to a mass analyzer 612. Mass analyzer 612 can be any mass analyzer, including quadrupole, time-of-flight (TOF), ion trap, magnetic sector mass analyzers as well as combinations thereof. A detector 614 detects ions emanating from mass analyzer 612. Detector 614 can be integral with mass analyzer 612. For example, in the case of a TOF mass analyzer, detector 614 can be a microchannel plate detector that counts intensity of ions, i.e., counts numbers of ions impinging it.

A raw data store 616 may provide permanent storage for storing the ion counts for analysis. For example, raw data store 616 can be an internal or external computer data storage device such as a disk, flash-based storage, and the like. An acquisition device 618 analyzes the stored data. Data can also be analyzed in real time without requiring storage in a storage medium. In real time analysis, detector 614 passes data to be analyzed directly to the acquisition device 618 without first storing it to permanent storage.

Collision cell 610 performs fragmentation of the precursor ions. Fragmentation can be used to determine the primary sequence of a peptide and subsequently lead to the identity of the originating protein. Collision cell 610 includes a gas such as helium, argon, nitrogen, air, or methane. When a charged precursor interacts with gas atoms, the resulting collisions can fragment the precursor by breaking it up into resulting fragment ions. Such fragmentation can be accomplished as using techniques described in Bateman by switching the voltage in a collision cell between a low voltage state (e.g., low energy, <5 V) which obtains MS spectra of the peptide precursor, with a high voltage state (e.g., high or elevated energy, >15V) which obtains MS spectra of the collisionally induced fragments of the precursors. High and low voltage may be referred to as high and low energy, since a high or low voltage respectively is used to impart kinetic energy to an ion.

Various protocols can be used to determine when and how to switch the voltage for such an MS/MS acquisition. For example, conventional methods trigger the voltage in either a targeted or data dependent mode (data-dependent analysis, DDA). These methods also include a coupled, gas-phase isolation (or pre-selection) of the targeted precursor. The low-energy spectra are obtained and examined by the software in real-time. When a desired mass reaches a specified intensity value in the low-energy spectrum, the voltage in the collision cell is switched to the high-energy state. The high-energy spectra are then obtained for the pre-selected precursor ion. These spectra contain fragments of the precursor peptide seen at low energy. After sufficient high-energy spectra are collected, the data acquisition reverts to low-energy in a continued search for precursor masses of suitable intensities for high-energy collisional analysis.

Different suitable methods may be used with a system as described herein to obtain ion information such as for precursor and product ions in connection with mass spectrometry for an analyzed sample. Although conventional switching techniques can be employed, embodiments may also use techniques described in Bateman which may be characterized as a fragmentation protocol in which the voltage is switched in a simple alternating cycle. This switching is done at a high enough frequency so that multiple high- and multiple low-energy spectra are contained within a single chromatographic peak. Unlike conventional switching protocols, the cycle is independent of the content of the data. Such switching techniques described in Bateman, provide for effectively simultaneous mass analysis of both precursor and product ions. In Bateman, using a high- and low-energy switching protocol may be applied as part of an LC/MS analysis of a single injection of a peptide mixture. In data acquired from the single injection or experimental run, the low-energy spectra contains ions primarily from unfragmented precursors, while the high-energy spectra contain ions primarily from fragmented precursors. For example, a portion of a precursor ion may be fragmented to form product ions, and the precursor and product ions are substantially simultaneously analyzed, either at the same time or, for example, in rapid succession through application of rapidly switching or alternating voltage to a collision cell of an MS module between a low voltage (e.g., generate primarily precursors) and a high or elevated voltage (e.g. generate primarily fragments) to regulate fragmentation. Operation of the MS in accordance with the foregoing techniques of Bateman by rapid succession of alternating between high (or elevated) and low energy may also be referred to herein as the Bateman technique and the high-low protocol.

The data acquired by the high-low protocol allows for the accurate determination of the retention times, mass-to-charge ratios, and intensities of all ions collected in both low- and high-energy modes. In general, different ions are seen in the two different modes, and the spectra acquired in each mode may then be further analyzed separately or in combination. The ions from a common precursor as seen in one or both modes will share the same retention times (and thus have substantially the same scan times) and peak shapes. The high-low protocol allows the meaningful comparison of different characteristics of the ions within a single mode and between modes. This comparison can then be used to group ions seen in both low-energy and high-energy spectra.

In summary, such as when operating the system using the Bateman technique, a sample 602 is injected into the LC/MS system. The LC/MS system produces two sets of spectra, a set of low-energy spectra and a set of high-energy spectra. The set of low-energy spectra contain primarily ions associated with precursors. The set of high-energy spectra contain primarily ions associated with fragments. These spectra are stored in a raw data store 616. After data acquisition, these spectra can be extracted from the raw data store 616 and displayed and processed by post-acquisition algorithms in the acquisition 618.

Metadata describing various parameters related to data acquisition may be generated alongside the raw data. This information may include a configuration of the mass spectrometer 604 (or other chromatography apparatus that acquires the data), which may define a data type. An identifier (e.g., a key) for a codec that is configured to decode the data may also be stored as part of the metadata and/or with the raw data. The metadata may be stored in a metadata catalog 622 in a document store 620.

The acquisition 618 may operate according to a workflow, providing visualizations of data to an analyst at each of the workflow steps and allowing the analyst to generate output data by performing processing specific to the workflow step. The workflow may be generated and retrieved via a client browser 624. As the acquisition 618 performs the steps of the workflow, it may read read raw data from a stream of data located in the raw data store 616. As the acquisition 618 performs the steps of the workflow, it may generate processed data that is stored in a metadata catalog 622 in a document store 620; alternatively or in addition, the processed data may be stored in a different location specified by a user of the acquisition 618. It may also generate audit records that may be stored in an audit log 626.

The exemplary embodiments described herein may be performed at the client browser 624 and acquisition 618, among other locations.

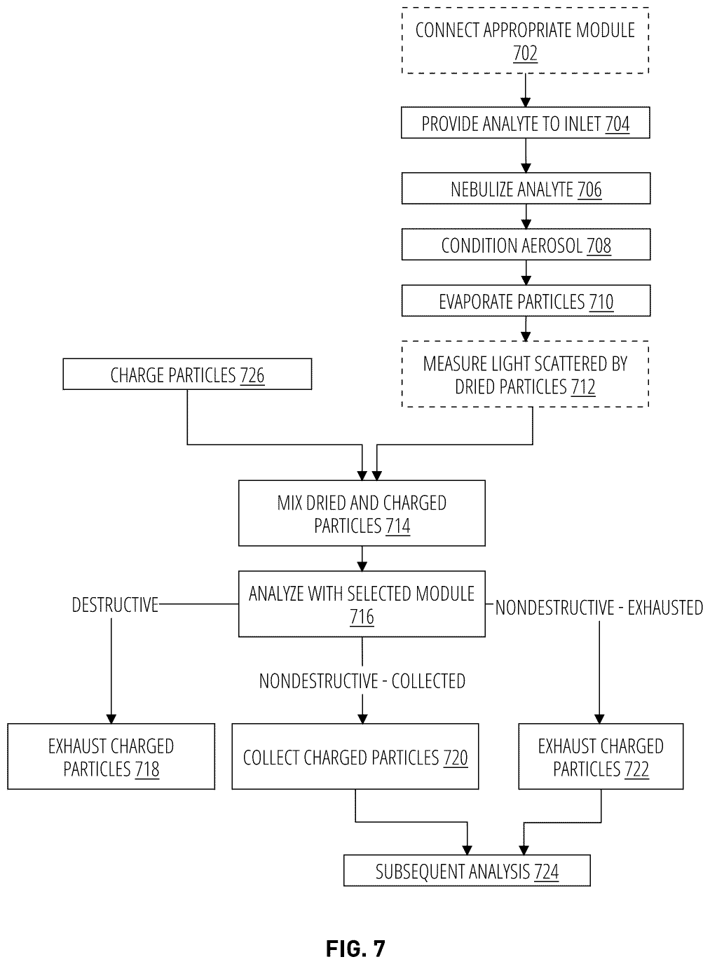

FIG. 7 illustrates an example routine for using the exemplary apparatuses described above. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method optionally includes connecting an appropriate module at block 702. For example, if the apparatus supports use of the destructive analysis module 308 and nondestructive analysis module 310 as alternatives, a user may connect a selected module using an adapter (FIG. 5A) or by changing a redirector such as the switching valve 506 (FIG. 5B).

An analyte may be provided to an inlet, such as the HPLC inlet 108, at block 704. As discussed above, the analyte may move to a pneumatic nebulizer 110 to be nebulized at block 706, and the resulting aerosol may then be conditioned in the spray chamber 112 at block 708. The solvent component of the conditioned particles may be evaporated in the heated evaporation tube 118 at block 710 to create dried particles.

The dried particles may optionally be subjected to a light scattering analysis by a light scattering unit 302 at block 712.

Meanwhile, a stream of charged particles may be generated at block 726. The charged particles may be generated by the charger 120. The dried and charged particles may be mixed in a mixing chamber 122 at block 714, and subjected to an ion trap 124.

Subsequently, the charged particles may be analyzed with the module selected at block 702 (or the default module(s), if no such module was selected) at block 716. In the case of the nondestructive analysis module 310, this may involve passing the charged particles through or near the detection tube/electrode 204. As the particles pass near/through it, they induce a counter-charge in the detection tube/electrode 204 that can be detected electronically. The counter charge from the detection tube/electrode 204 may be provided as an input to a charge sensitive amplifier 206, which converts the input charge into a voltage and amplifies it (e.g., provides an output voltage proportional to the input charge). An analog/digital converter 132 may convert the output of the charge sensitive amplifier 206.

The next step depends on what type of module (destructive or nondestructive) is being used. In the case of a destructive analysis, any remaining particles that did not impact on the electrometer filter 126 may be exhausted at block 718.

In the case of a nondestructive analysis, the particles may be collected at a collector (block 720) or exhausted to a further analysis device (block 722), such as a mass spectrometer. Then, subsequent analysis may be performed by a further analysis device at block 724.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus for use with a charged aerosol detector (CAD) front-end, the apparatus comprising:
a detection tube or electrode configured to receive charged particles, wherein the detection tube or electrode is configured so that charged particles passing through or near the detection tube or electrode induce a counter charge on the detection tube or electrode;
a detector configured to detect the counter charge; and
an outlet configured to output the charged particles after passing through or near the detection tube or electrode, wherein the charged particles remain available for further analysis after passing through the outlet.

2. The apparatus of claim 1, further comprising a charge sensitive amplifier configured to receive an input charge corresponding to the detected counter charge and generate an output voltage that is proportional to the input charge.

3. The apparatus of claim 1, wherein the outlet comprises a collection substrate configured to collect the charged particles after passing through or near the detection tube or electrode.

4. The apparatus of claim 3, further comprising a subsequent analysis device configured to receive the charged particles collected on the collection substrate.

5. The apparatus of claim 4, wherein the subsequent analysis device is a Fourier-transform infrared (FTIR) spectrometer or a matrix-assisted laser desorption/ionization (MALDI) mass spectrometer (MS).

6. The apparatus of claim 1, wherein the outlet comprises an exhaust that allows the particles to pass in real-time to a subsequent analysis device.

7. The apparatus of claim 6, wherein the subsequent analysis device is a particle beam mass spectrometer or a laser ablation-ionization mass spectrometer or an extractive electrospray interface to a mass spectrometer.

8. The apparatus of claim 1, wherein the detection tube or electrode, detector, and outlet form a nondestructive CAD module, further comprising a destructive CAD module.

9. The apparatus of claim 8, wherein the destructive CAD module is fluidically connected with the outlet so that the nondestructive CAD module and the destructive CAD module are provided in series with each other.

10. The apparatus of claim 8, wherein the nondestructive CAD module and the destructive CAD module are provided in parallel with each other, and further comprising a redirector configured to selectively direct the charged particles to the nondestructive CAD module or the destructive CAD module.

11. The apparatus of claim 10, wherein the redirector is a switching valve comprising a destructive path and a nondestructive path, the charged particles being directed into the destructive path or nondestructive path depending on a state of the switching valve.

12. The apparatus of claim 10, wherein redirector is an electrostatic or pneumatic redirector configured to direct the charged particles to the destructive CAD module or the nondestructive CAD module.

13. The apparatus of claim 8, further comprising a first adapter on the nondestructive CAD module configured to mate with a corresponding adapter on the CAD front-end and a second adapter on the destructive CAD module configured to mate with the corresponding adapter on the CAD front-end.

14. The apparatus of claim 1, further comprising a light scattering unit having a light source and a light scattering detector, the light scattering unit provided upstream of the detection tube or electrode.

15. The apparatus of claim 1, wherein the charged aerosol detector front-end comprises:
an inlet configured to provide an analyte;
a nebulizer configured to receive the analyte and form an aerosol comprising the analyte;
a spray chamber configured to condition the aerosol by removing droplets larger than a predetermined size;
an evaporation tube configured to condition remaining droplets in the aerosol by evaporating solvent from the remaining droplets to form dried particles;
a charger configured to output charged particles;
a mixing chamber configured to receive the dried particles and the charged particles and to mix the dried particles and charged particles together to form mixed particles; and
an ion trap configured to receive the mixed particles and output selected particles from the mixed particles, wherein the detection tube or electrode is configured to receive the selected particles from the ion trap.

16. An apparatus comprising:
an inlet configured to provide an analyte;
a nebulizer configured to receive the analyte and form an aerosol comprising the analyte;
a spray chamber configured to condition the aerosol by removing droplets larger than a predetermined size;
an evaporation tube configured to condition remaining droplets in the aerosol by evaporating solvent from the remaining droplets to form dried particles;
a charger configured to output charged particles;
a mixing chamber configured to receive the dried particles and the charged particles and to mix the dried particles and charged particles together to form mixed particles;
an ion trap configured to receive the mixed particles and output selected particles from the mixed particles, wherein the detection tube or electrode is configured to receive the selected particles from the ion trap; and
a light-scattering unit comprising a light source and a scattered light detector, wherein the light scattering unit is arranged upstream of the mixing chamber to measure light scattered by the dried particles before the dried particles are mixed with the charged particles.

17. A method comprising:
providing a CAD analyte to an inlet of the CAD front-end of claim 1;
analyzing the CAD analyte with the detection tube or electrode and the detector; and
performing a further analysis on the charged particles output at the outlet.

18. The method of claim 17, further comprising performing a light scattering analysis prior to analyzing the CAD analyte with the detection tube or electrode and the detector.

19. The method of claim 17, wherein the detection tube or electrode, detector, and outlet form a nondestructive CAD module, and further comprising providing a destructive CAD module.

20. The method of claim 19, further comprising switching between the nondestructive CAD module and the destructive CAD module.
